(19) United States
(12) Patent Application Publication
(10) Pub. No.: US 2014/0124706 A1
(43) Pub. Date: May 8, 2014

(54) PROCESS FOR PREPARING CHLOROSILANES BY MEANS OF HIGH-BOILING CHLOROSILANES OR CHLOROSILANE-CONTAINING MIXTURES

(71) Applicants: Ekkehard Müh, Rheinfelden (DE); Hartwig Rauleder, Rheinfelden (DE); Reinhold Schork, Grasellenbach (DE)

(72) Inventors: Ekkehard Müh, Rheinfelden (DE); Hartwig Rauleder, Rheinfelden (DE); Reinhold Schork, Grasellenbach (DE)

(73) Assignee: Evonik Degussa GmbH, Essen (DE)

(21) Appl. No.: 14/111,643

(22) PCT Filed: Feb. 28, 2012
(86) PCT No.: PCT/EP12/53368

§ 371 Date: Dec. 20, 2013

(30) Foreign Application Priority Data
Apr. 14, 2011 (DE) 10 2011 007 381.7
Aug. 12, 2011 (DE) 10 2011 110 040.0

(51) Int. Cl. C01B 33/107

(52) U.S. Cl. CPC C01B 33/10742
USPC 252/373; 423/341; 423/342

(57) ABSTRACT

The invention relates to a process for preparing chlorosilanes of the general formula H₄₋ₙSiClₙ with n=1, 2, 3, and/or 4, the process being characterized in that silicon in a silicon bed is reacted with Cl₂ or HCl and with at least one silicon-containing compound in a reactor.

The invention relates to a process for preparing chlorosilanes of the general formula H₄₋ₙSiClₙ with n=1, 2, 3, and/or 4 by reaction of silicon in a silicon bed with Cl₂ or HCl and with at least one silicon-containing compound.

### PRIOR ART

Chlorosilanes play a large part in the preparation of diverse substances. Chlorosilanes find application in the preparation of fumed silica, organosilanes and silicic esters. They are also starting product for high-purity silicon which is needed in the semiconductor industry for producing integrated circuits or in the photovoltaic industry for producing solar cells.

In view of the great importance of this group of substances it is necessary that these compounds can be produced economically. Chlorosilanes can be obtained from Si by reaction with HCl or chlorine.

It is known that in the chlorosilane preparation processes and in processes which use chlorosilanes as a reactant, higher chlorosilanes are produced together with siloxanes. Higher chlorosilanes and siloxanes in the context of the invention are chlorine-containing or chlorine-free siloxanes, chlorine-containing or chlorine-free silanes having more than one Si atom, the individual Si atoms being joined to one another and forming branched or unbranched chains, ring systems, and/or mixtures thereof.

DE 10 2006 009 953 A1 discloses a process for preparing fumed silica by condensing the gas given off from the deposition of polycrystalline silicon from chlorosilane and hydrogen. Subsequently, in a distillation column, a high-boilers fraction is isolated from the condensate and evaporated. It comprises a fraction of chlorosilane vapour, which is reacted in a flame with hydrogen and air or oxygen to form fumed silica.

DE 10 2006 009 954 A1 is the closest prior art for the invention. The specification discloses the preparation of trichlorosilane by reaction of metallurgical silicon and hydrogen chloride at a temperature from 290° C. to 400° C. in which high-boiling compounds are fed into a fluidized bed reactor. The high-boilers are formed as constituents of gases given off in the preparation of polycrystalline silicon or trichlorosilane. The fluidized bed reactor allows reutilization of the high-boilers, which are returned via a saturator to the fluidized bed reactor. In the saturator, the high-boilers are combined with a portion of the hydrogen chloride stream. This mixture is subsequently introduced into the main stream, composed of HCl and added metallic silicon. The multiplicity of these process constituents permits efficient preparation of chlorosilanes.

The object of the present invention, accordingly, is to provide an alternative process for producing chlorosilanes, SiCl₄, HSiCl₃, H₂SiCl₂ and H₃SiCl by reaction of Si with Cl₂ and/or HCl and with higher chlorine-free or chlorine-containing silanes and/or siloxanes that is easier to realize and has a similar or better yield.

Surprisingly it has emerged that chlorinated silicon compounds with only one silicon atom can be prepared by reacting higher chlorine-containing or chlorine-free silanes and/or siloxanes with the Si in a silicon bed in a reactor together with Cl₂ or HCl.

The present invention accordingly provides a process for preparing chlorosilanes of the general formula H₄₋ₙSiClₙ with n=1, 2, 3, and/or 4, which is characterized in that in at least one silicon-containing reactor silicon in a silicon bed is reacted with Cl₂ or HCl and with at least one silicon-containing compound.

The process of the invention has the advantage of utilizing the very high temperatures owing to the highly exothermic reaction between the silicon and HCl or chlorine for the cleavage reactions.

The heat given off by the reaction is so high that the reactor must be permanently cooled in order to remove this thermal energy. A further advantage of the claimed process, therefore, is that the high temperature prevailing in the reactor permits simple liquid introduction, through nozzles or as a stream, of the high-boilers. Consequently, the saturator proposed in DE 10 2006 009 954 A1 is not needed. Likewise an advantage of the process of the invention is that the composition of the high-boilers introduced as a stream or through nozzles, in terms of chlorine-free and/or chlorine-containing polysilanes and/or in terms of chlorine-free and/or chlorine-containing polysiloxanes, can be modified without reducing the yield of the chlorosilanes obtained by the process of the invention. In the context of the invention, the expression “poly-” identifies compounds having 2 to 20 silicon atoms.

In addition, the consumption of heat associated with the evaporation of the higher silanes contributes to the control of the reaction. This is a further advantage of the process of the invention. Another process-engineering advantage is that, in contrast to the fluidized bed reactor, the reactor used in the process of the invention can be operated with silicon chunks in the silicon bed instead of with silicon powder, e.g. with ground silicon.

Another advantage of the process of the invention is its improved tolerance with respect to impurities in the silicon. An Si content of at least 96% is sufficient, instead of the 98% required when using a fluidized bed reactor.

The invention is elucidated in more detail below.

In the process of the invention it is preferred to use a fixed, fluidized and/or stirred bed reactor.

It may also be advantageous if the Si in a silicon bed is reacted with Cl₂ or HCl and with at least one silicon-containing compound in the form of a mixture G,
(G) comprising polysilanes having at least 2 Si atoms, polychlorosilanes, polymethylchlorosilanes, chlorine-containing polysiloxanes, non-chlorine-containing polysiloxanes, polymethylchlorosiloxanes, HSiCl₃, (CH₃)HSiCl₂, (CH₃)H₂SiCl, CH₃SiCl₃, (CH₃)₂SiCl₂, (CH₃)₃SiCl, CH₃SiH₃, (CH₃)₂SiH₂, (CH₃)₃SiH, and/or SiCl₄.

HSiCl₃, trichlorosilane, is also abbreviated to “TCS”.

In the process of the invention, the silicon bed can be subjected to a stream of Cl₂ or HCl preferably below the grating of the fixed and/or fluidized bed reactor, and the mixture G stream can be introduced below or above the grating.

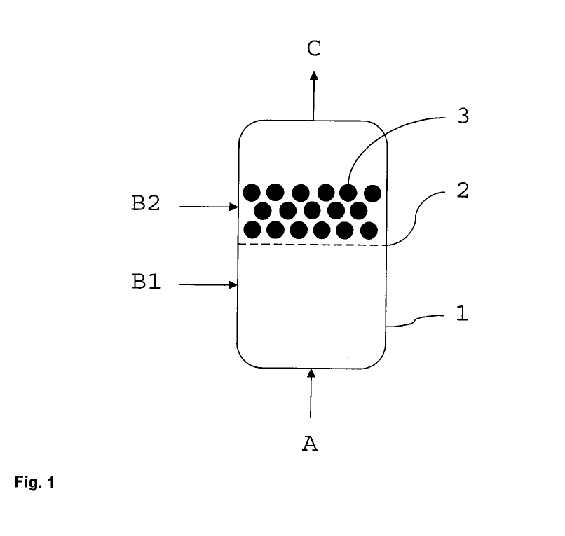

FIG. 1 shows the arrangement used in accordance with the invention when the silicon bed is subjected to an HCl stream below the grating of the reactor. The meanings of the reference symbols are as follows:

| | |
|---|---|
| 1 | Reactor shell |
| 2 | Grating |
| 3 | Silicon bed |
| A | Inlet for HCl |
| B1 | Inlet for G below the grating |
| B2 | Inlet for G above the grating |
| C | Outlet for reaction products |

In the process, furthermore, the reactor may be set preferably to a temperature of 800° C. to 1300° C. in the reactor centre.

In the process of the invention the mixture G with particular preference is selected from polysilanes and polysiloxanes, polysilanes and SiCl₄, polysilanes and HSiCl₃, polysilanes and polysiloxanes and SiCl₄, polysilanes and polysiloxanes and HSiCl₃, polysilanes and polysiloxanes and SiCl₄ and HSiCl₃, polysiloxanes and SiCl₄, polysiloxanes and HSiCl₃, or polysiloxanes and SiCl₄ and HSiCl₃. In the process of the invention these mixture alternatives are, very preferably, used together with HCl. Also with particular preference it is possible to use trichlorodisilane, tetrachlorodisilane, pentachlorodisilane, hexachlorodisilane, octachlorotrisilane, decachlorotetrasilane, or a mixture of these silanes, and/or tetrachlorodisiloxane, pentachlorodisiloxane, hexachlorodisiloxane, octachlorotrisiloxane, decachlorotetrasiloxane, or a mixture of these siloxanes.

In the process of the invention it may likewise be advantageous to select the silicon-containing compound from chlorine-containing or chlorine-free siloxanes or silanes having the general formula SiₙHₓCl_{y}, linear with n=1 to 20, x+y=2n+2, or cyclic with n=3 to 8, x+y=2n.

It may likewise be advantageous if the silicon bed is subjected to a stream of at least one silicon-containing compound which is liquid under standard conditions. Standard conditions in the context of the invention are synonymous with an air temperature of 20° C. at an air pressure of 1013 hPa.

If Cl₂ and not HCl is used in the process of the invention, a temperature of 900° C. to 1300° C., preferably, may be set in the reactor centre, or, if HCl and not Cl₂ is used, a temperature in the reactor centre of preferably from 800° C. to 1200° C., more preferably from 900° C. to 1100° C., very preferably from 950° C. to 1050° C. may be set in the reactor centre.

Also with particular preference, cooling may take place via the shell, by means of heat-transfer oil, for example, and/or the temperature may be controlled via the vaporization enthalpy of the silicon bed introduced as a stream and/or subjected to a stream of liquid high-boilers, preferably with siloxanes, polysiloxanes or silanes, polysilanes. Likewise with particular preference, in the process of the invention, the temperature in the reactor centre is adjusted via the hydrogen chloride flow rate or via the flow rate of the introduced mixture G stream.

Likewise provided by the invention are chlorosilanes or a mixture with chlorosilanes which are obtained by the process. Preference is given to chlorosilanes as a mixture together with high-boilers, comprising from 10% to 20% by weight of HSiCl₃ or 80% to 90% by weight of SiCl₄ and 0.1% to 3% by weight of dichlorosilane, and from 0.1 to 3% by weight of high-boilers. High-boilers in the context of the invention are chlorine-containing or chlorine-free siloxanes, or silanes having the general formula SiₙHₓCl_{y}, linear with n=1 to 20, x+y=2n+2, or cyclic with n=3 to 8, x+y=2n.

Preferably, by the process of the invention, a mixture of chlorosilanes is obtained that comprises from 10% to 15% by weight of HSiCl₃, depending on the temperature to which the reactor centre is adjusted.

The mixture of high-boilers and chlorosilanes is preferably returned as reactant to the reactor, preferably to the fixed bed reactor, and is reacted by the process of the invention, very preferably with HCl.

With particular preference, the more volatile chlorosilane or chlorosilanes, dichlorosilane, HSiCl₃, SiCl₄, are removed from the reaction mixture by distillation, and the mixture which remains, comprising high-boilers, is returned as reactant to the fixed bed reactor and reacted by the process of the invention, especially preferably with HCl.

Also with particular preference, the distillative removal of the chlorosilanes, the subsequent recycling of the remaining mixture and its reaction in accordance with the invention may be carried out at least twice, more preferably as often as desired.

In addition to the mixtures comprising high-boilers that are formed in the preparation of chlorosilane, it is also possible to use mixtures of silane, polysilane and/or siloxane that form in processes referred to at the outset, such as the preparation of silicon, for example, starting from precursors such as monosilane, monochlorosilane, dichlorosilane, trichiorosilane and silicon tetrachloride.

Also preferred is any desired combination of the implementation of the process of the invention with Cl₂ or HCl and with any mixture G and any temperature.

The invention is elucidated below by means of examples.

In all of the examples, a fixed bed reactor was packed with a silicon bed, which lies on a grating, and was subjected from below to a stream of hydrogen chloride gas or chlorine gas. In the course of passage through the bed, the hydrogen chloride gas or chlorine gas reacted with Si in an exothermic reaction to form chlorosilane.

The reaction of silicon with chlorine produces an enthalpy change of ΔHR=−665.7 kJ/mol; the reaction of silicon with HCl produces LHR=−288.7 kJ/mol.

Subjecting the bed to a stream of chlorine gas produced SiCl₄; subjecting it to a stream of hydrogen chloride gas produced a mixture composed substantially of SiCl₄ and HSiCl₃. The composition of the crude silane mixture formed when using HCl as chlorinating agent, was approximately 11%-24% HSiCl₃, 89%-76% SiCl₄ and 0.1%-2% dichlorosilane, with traces of monochlorosilane. In addition, 0.1%-10% of high-boilers were formed, mainly perchlorinated and partly chlorinated polysiloxanes.

In the reactor centre, temperatures of about 800° C.-1200° C. were attained. The reactor had to be cooled because of the high level of release of heat of reaction.

### Comparative Example

A fixed bed reactor was operated as described above. Fed into the reactor, below the silicon bed, comprising metallurgical silicon with an Si content of at least 96%, were 74 kg/h of HCl. Analysis of the crude silane mixture formed, by gas chromatography, gave a composition of approximately 15% HSiCl₃, 82.8% SiCl₄, 1.1% dichlorosilane, and traces of monochlorosilane.

In addition, 1.1% of high-boilers were formed, mainly perchlorinated and partly chlorinated polysiloxanes.

### EXAMPLE 1

A fixed bed reactor was operated as described in the comparative example. In accordance with the invention, additionally, 3.9 kg/h of high-boilers were introduced as a stream below the grating of the fixed bed reactor.

Siloxanes reacted to form SiO₂ and chlorosilanes, mainly SiCl₄ and HSiCl₃. Chlorine-containing or chlorine-free polysilanes likewise reacted to form chlorosilanes, mainly SiCl₄ and HSiCl₃.

In this example, the high-boilers introduced as a stream comprised
in one case, 42% of chlorine-containing and chlorine-free siloxanes, and 58% of chlorine-containing and chlorine-free polysilanes,
in another case
   4 parts of a mixture of 42% of chlorine-containing and chlorine-free siloxanes and 58% of chlorine-containing and chlorine-free polysilanes with
   1 part of SiCl₄

Analysis of the chlorosilanes prepared in accordance with the invention, by gas chromatography, in both cases gave a composition of 14.9% HSiCl₃, 83.1% SiCl₄, 0.9% dichlorosilane, traces of monochlorosilane, and 1.1% high-boilers, mainly comprising perchlorinated and partly chlorinated polysiloxanes.

It was found, accordingly, that the introduction of polysilane streams and/or polysiloxane streams disturbed neither the course of the reaction nor the composition of the chlorosilanes prepared or obtained in accordance with the invention.

### EXAMPLE 2

The procedure, in accordance with the invention, was as in Example 1, but with the difference that the high-boilers were introduced in a stream amounting to 4.1 kg/h above the grating. Analysis of the chlorosilanes prepared in accordance with the invention, by gas chromatography, gave a composition of about 14.6% HSiCl₃, 82.9% SiCl₄, 1.2% dichlorosilane, traces of monochlorosilane, and 1.3% high-boilers, mainly comprising perchlorinated and partly chlorinated polysiloxanes.

1. A process for preparing a chlorosilane of formula H₄₋ₙSiClₙ where n=1, 2, 3, or 4,
the process comprising:
silicon in a silicon bed with Cl₂ or HCl, and with at least one silicon-containing compound in a reactor.

2. The process according to claim 1, wherein the reacting is carried out in a fixed, fluidized and/or stirred bed reactor.

3. The process according to claim 1, wherein the at least one silicon-containing compound is present in the form of a mixture G, comprising at least two of:
a polysilane having at least 2 Si atoms, a polychlorosilane, a polymethylchlorosilane, a chlorine-containing polysiloxane, a non-chlorine-containing polysiloxane, a polymethylchlorosiloxane, HSiCl₃, (CH₃)HSiCl₂, (CH₃)H₂SiCl, CH₃SiCl₃, (CH₃)₂SiCl₂, (CH₃)₃SiCl, CH₃SiH₃, (CH₃)₂SiH₂, (CH₃)₃SiH, and SiCl₄.

4. The process according to claim 2 comprising:
subjecting the silicon bed below a grating of the fixed and/or fluidized bed reactor to a stream of Cl₂ or HCl, and
introducing a mixture G stream below or above the grating.

5. The process according to claim 1,
wherein a temperature at the center of the reactor is adjusted to a 800° C. to 1300° C.

6. The process according to claim 3,
wherein the mixture G is a mixture of
a polysilane and a polysiloxane,
a polysilane and SiCl₄,
a polysilane and HSiCl₃,
a polysilane and a polysiloxane and SiCl₄,
a polysilane and a polysiloxane and HSiCl₃,
a polysilane and a polysiloxane and SiCl₄ and HSiCl₃,
a polysiloxane and SiCl₄,
a polysiloxane and HSiCl₃, or
a polysiloxane and SiCl₄ and HSiCl₃.

7. The process according to claim 1,
wherein the at least one silicon-containing compound being is selected from the group consisting of:
a chlorine-containing siloxane,
a chlorine-free siloxane, and
a silane having formula of SiₙHₓCl_{y},
wherein n=1 to 20, and x+y=2n+2 for a linear silane, or
n=3 to 8, and x+y=2n for a cyclic silane.

8. The process according to claim 1,
wherein a temperature at the center of the reactor is adjusted,
if Cl₂ and not HCl is used, to 900° C. to 1300° C., or,
if HCl and not Cl₂ is used, to 800° C. to 1200° C.

9. The process according to claim 3,
wherein the temperature at the center of the reactor is adjusted via a hydrogen chloride flow rate or a flow rate of an introduced mixture G stream.

10. The process according to claim 1, further comprising:
subjecting the silicon bed to a stream of at least one liquid silicon-containing compound.

11. A chlorosilane obtained by the process according to claim 1.

12. The chlorosilane according to claim 11, the chlorosilane comprising:
from 10 to 20% by weight of HSiCl₃, 80 to 90% by weight of SiCl₄ and 0.1 to 3% by weight of dichlorosilane, and
from 0.1 to 3% by weight of at least one high-boiler high boilers.

13. The process according to claim 8,
wherein a temperature at the center of the reactor is adjusted,
if HCl and not Cl₂ is used, to 900° C. to 1100° C.

14. The process according to claim 13,
wherein the temperature at the center of the reactor is adjusted,
if HCl and not Cl₂ is used, to 950° C. to 1050° C.
